(19) United States
(12) Patent Application Publication
(10) Pub. No.: US 2006/0167587 A1
(43) Pub. Date: Jul. 27, 2006

(54) Auto Motion: Robot Guidance for Manufacturing

(76) Inventor: Dale Read, London (GB)

Correspondence Address: Eckert Seamans Cherin & Mellott, LLC;US Street Tower, 600 Grant Street, 44th Floor, Pittsburgh, PA, 15219, US

(21) Appl. No.: 10/502,003

(22) PCT Filed: Oct. 18, 2002
(86) PCT No.: PCT/GB02/04691

§ 371 Date: Jul. 27, 2005

(30) Foreign Application Priority Data
Oct. 18, 2001 (GB) 0125079.4

(51) Int. Cl. G06F 19/00

(52) U.S. Cl. 700/245

(57) ABSTRACT

A robot manufacturing facility, for example for use in automobile manufacture, includes at least one robot for acting on a workpiece or intermediate product of a pre-calculated shape and dimensions at a pre-calculated position and orientation relative to a reference frame. The robot includes a body or base structure, at least one end effector movable with respect to the body or base structure for acting on workpieces, means for moving the end effector and sensing means for sensing the position of the each effector. The sensing means preferably includes a laser light source carried by the robot and means for detecting laser light, from said source, reflected from the workpiece. The movement of the end effector is controlled according to a predetermined program, modified in accordance with signals from the sending means, so that the robot is able to compensate for departures from pre-calculated values of the position and orientation and/or shape and/or dimensions of the workpiece.

### TECHNICAL FIELD

THE PRESENT INVENTION relates to robot automation, particularly in the customisation of robot actions to the immediate situation presented, whether dimensional variation in the target to be operated on, or motion on a conveyor.

### BACKGROUND OF THE INVENTION

Robot automation has long been available for replacing manual operators in highly repetitive tasks. A robot's reach, payload capacity, repeatability and ability to work continuously and in hazardous areas are far superior to that of a human. However, robots have not so far been able to match the hand-eye co-ordination of people and their ability to make instant decisions based on visually observed circumstances.

In the automotive industry, robot automation has therefore thrived in body construction where the panels are clamped in a known position, and where simple sensing (through proximity or photoelectric sensors) can determine which of several defined programs must be run for that particular variant.

Operations on moving conveyors, the foundation of mass production automobile companies, are, however, still very labour intensive. The number of parts and people required to build a car requires compact workstations and flexible conveyor systems with easy access for personnel.

Vehicles travel along production lines with small amounts of lateral shift, rotation and variable seating of the body on the skid (carrier) in addition to the manufacturing variation in the product itself. Operators take these minor variations in their stride, subconsciously adapting their repeatable action to each approaching vehicle. Robots that follow a predefined path, however, would often miss their target and produce considerable amounts of scrap product.

The traditional approach to robot automation is to break the flow and redirect vehicles to a clamping station where the tooling holds the vehicle in a known position for the robots to perform their task. In order to keep up with the tight cycle times of the line, fast-in and fast-out roller beds are often required to avoid creating a bottleneck.

High investment in tooling is thus a pre-requisite to a robot cell which adversely affects the payback analysis, takes up large areas of plant space and creates more equipment to maintain.

A need persists for robot cells that can be installed around existing conveyors, in a space approximately equivalent to an operator's workstation which can consistently carry out a task with high quality regardless of build tolerances, orientation or speed of the approaching vehicle.

### SUMMARY OF THE INVENTION

The present invention provides repeatable methodologies which are particularly, (but not exclusively) applicable to the use of robot automation to carry out tasks on workpieces on continuously moving conveyors and/or with considerable dimensional variability without high investment in tooling.

According to one aspect of the present invention, there is provided a robot manufacturing facility including at least one robot for acting on a workpiece or intermediate product of a pre-calculated shape and dimensions at a pre-calculated position and orientation relative to a reference frame, the robot including a body or base structure, at least one member movable with respect to said body or base structure for acting on such workpiece or intermediate product, means for effecting such movement and sensing means for sensing the position of said member, the last noted means including means for sensing the position of the workpiece or intermediate product relative to the robot or to said member thereof and means for controlling the movement of said member relative to said body or base structure according to a predetermined program, modified in accordance with signals from said sensing means, whereby the robot is able to compensate for departures from said pre-calculated values of the position and orientation and/or shape and/or dimensions of the workpiece or intermediate product.

According to another aspect of the invention there is provided a method of programming an industrial robot, comprising developing a 3D virtual model of a workpiece or intermediate product, determining, on a virtual basis, required movements of a robot tool relative to such model for a manufacturing procedure to be carried out thereon, providing to a computer program data defined by said 3D virtual model and said virtual required movements, and controlling a real robot, in a real workshop/factory space in relation to a real workpiece or product, the real robot being provided with sensing means for sensing the positions relative to a fixed datum of such robot of key parts of such product identified by said sensing means in conjunction with said program and the program being arranged to control the moving parts of said robot to reproduce the predetermined movements of the same, relative to the workpiece.

In one embodiment of the invention, a robot in an ‘on the fly’ cell continuously searches for its (moving) target during the immediate operation) which the robot is arranged to perform. In this embodiment the robot may be a six-axis industrial robot with control cabinet and an end effector appropriate to carrying out the task concerned.

Also included in the preferred embodiments is conveyor tracking functionality which enables the robot to follow the conveyor speed so as to be stationary relative to it. This routine is performed by an additional software package.

Preferably, said sensing means is located on the part of the robot, (herein also termed the “end effectoer”), which directly acts on the workpiece or intermediate product or on a part as close as possible to the first-mentioned part.

Mounted on the end effector in a preferred embodiment intended for use in vehicle manufacture, are a sufficient number of sensors linked back to a data processing computer to make up a robot guidance system for continuously identifying the exact offset to the target points within the vehicle body.

Additional hardware and software serves to co-ordinate the above systems and overcome errors inherent in the existing equipment making it possible to perform actions with high accuracy on a moving conveyor, which it has previously not been possible to automate.

Embodiments of the present invention are characterised by adaptive operation of robots. That is to say the robots respond to real-time factors and adapt their movements to take account of variations in such external factors. For example, a robotic vehicle manufacturing facility embodying the invention may utilise the technique of pre-measuring the profile of an individual vehicle before using the information in subsequent operations.

A facility embodying the invention may, for example, include one or many six-axis industrial robots each with a laser displacement sensor mounted on the end effector. The robots may execute a series of movements to aim the sensor (s) at multiple points. A data processing computer stores the measurements and makes calculations.

Subsequent robot operations execute a variable action, depending on the measurements taken, to tailor their action to the immediate situation.

Additional hardware and inventive software by Cimac is required to co-ordinate these systems and alter downstream robot paths accordingly, for customised vehicle production. By way of example, there are set out below some manufacturing processes which may be carried out using a robotic manufacturing facility in accordance with the invention.

### EXAMPLES

1. Robot Glazing

Glazing refers to the process of fitting fixed glass windows into a vehicle. These include the front windscreen, rear window and non-opening side glass such as rear quarter-lights. Typically, glass must be first cleaned and primed, then a polyurethane (PU) glue bead applied. Both these operations have previously been automated with robots but not using the techniques of the present application.

The final operation is inserting the glass into the vehicle.

As explained in greater detail below, in a facility embodying the present invention, these steps may be carried out while the vehicle is moving along a conveyor, e.g. on an assembly line.

2. Robot Decking

Decking refers to the process of marrying the engine, transmission, powertrain, axles and suspension elements to the vehicle underbody. The components must all be raised up into the underbody and secured by bolts which must be tightened to a specified torque.

Traditionally this is a highly labour-intensive and unergonomic operation, with high levels of fixed tooling and significant safety implications. The techniques of the present invention have enabled this operation to be automated with robots for the first time.

3. Robot Instrument Panel Assembly

The instrument panel, also known as dash panel or cockpit, has become an extremely large and heavy module in automobiles and always requires assisters to manoeuvre it into place, avoiding scratching by the B-pillar (i.e. the vertical strut on each side between the floor pan and the vehicle roof just behind the front door). It can be a structural component but is always an aesthetic one and it is important to secure accurate and centralisation of the instrument panel between the A-pillars, (i.e. the two struts extending upwardly and rearwardly at either side of the front windscreen, from the engine bay to the roof).

4. Robot Sealer Deck

After corrosion protection and before painting, all the seams of a vehicle body are usually filled with a mastic bead which seals and makes it watertight, but also has a cosmetic purpose. Traditional robot sealer automation yields variable quality results and sealer decks are highly labour intensive. The techniques of the present invention have finally made fully automated high quality sealer decks possible.

Other Concepts

The techniques above may be equally applied to other automotive processes.

These include but are not limited to the following concepts already under development:

Front/rear seat insertion and assembly

Roof module preparation and assembly

Wheels to car assembly

Spare wheel and pod to car

Battery insertion

Transmission to engine assembly

Doors off and on

Pedal box fit

Although part insertion on automotive assembly lines is used here as a generic example, the methods are equally applicable to:
All automotive plant areas—body construction, paint, assembly, powertrain
Other processes—sealer application, paint spraying, welding
Other discrete manufacturing industries—component suppliers, white goods

The implementation of these processes and other objects, features and advantages of the present invention will become apparent to those skilled in the art through the detailed description and drawings provided below.

### DESCRIPTION OF DRAWINGS

In the accompanying drawings:—

FIG. 1 is a diagram showing a robot cell in a vehicle assembly line;

FIGS. 2a to 2d illustrate operation of a glazing cell embodying the invention;

FIGS. 3a to 3d illustrate operation of a decking cell embodying the invention;

FIGS. 4a to 4d illustrate operation of an instrument panel insertion cell embodying the invention;

FIGS. 5a to 5c illustrate operation of a sealer deck embodying the invention.

### DETAILED DESCRIPTION

It is envisaged that the present invention will be implemented with a combination of electrical hardware and software, design, installation and commissioning. This software will take the form of robot programs and Programmable Logic Controller (PLC) ladder logic programs, and robot guidance data processing. These perform their functions in the manner described below and hence form the links which bind the elements of the facility together.

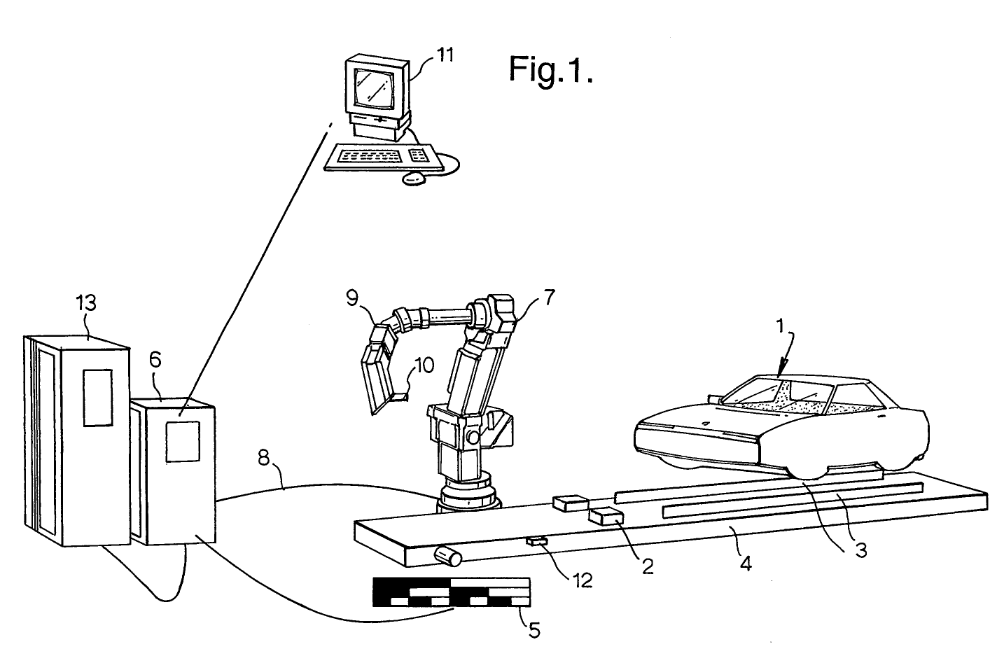

‘On the fly’ Robot Automation (Numbers Refer to Elements of FIG. 1)

It will be understood that, in the following, a vehicle being assembled, or at least the body of a vehicle being assembled, is supported on a skid 3 carried by, or at least progressively moved by, a conveyor 4, e.g. in a straight line, through a succession of work stations, herein referred to also as ‘cells’ in each of which a particular operation is carried out, or component fitted, by a robot assigned to that cell.

The process commences with indication of an approaching vehicle (1) from the activation of two proximity switches or photoelectric sensors (2) by the skid (3). At this point the position of the vehicle (1) on the conveyor (4) is known. Pulses from the digital encoder (5) on an axle of the conveyor drive, for example are sent to robot controller (6) which counts up from zero until the process cycle is complete. The conveyor tracking system thus knows the distance travelled and calculates the instantaneous speed of the vehicle (1). Even if the conveyor (4) stops or changes speed, the robot controller (6) still has a frame of reference for the vehicle (1). This synchronisation routine is performed in the robot controller (6) as a background task by the software.

The next step is to identify the exact target location within the moving frame of reference. The robot (7), having gripped the part for assembly (8) in its purpose built end-effector (9), positions it a safe distance away from the nominal target point. ‘Safe’ here refers to zero opportunity for collision. The conveyor tracking software in the robot controller (6) manipulates the robot's axes to maintain this distance as the vehicle (1) moves along. This may be achieved with a fixed robot base, but a seventh axis slider may also be used, (i.e. permitting back movement of the robot in the conveying direction).

From this position, which is effectively stationary relative to the vehicle (1), the robot guidance sensors (10) take multiple readings to measure the exact displacements to key locators which define the target. This can be done through reflective sensors which identify edges surrounding the destination area, or point or profile distance measurement lasers. The robot guidance PC (11) program processes (‘number crunches’) this data to calculate the exact dimensions and orientation of the target and its displacement from the current position. The offsets required for the robot (7) to place the part into the target are sent over a serial connection.

In theory, from this position, by superimposing a programmed assembly process onto the moving frame of reference, the robot (7) should be able to use the offsets to put the part directly into the target.

However, a problem occurs which requires an inventive step to overcome. Conveyor motion is not smooth like the axle rotational speed, but lurches with a sinusoidal or quasi-sinusoidal variation owing to the way a chain rides over a drive sprocket. As the robot (7) tracks the smooth axle motion, the actual offset between the robot and vehicle (1) on the conveyor (4) changes. Hence it is impossible to guarantee accurate insertion without some further refinement.

Placing an encoder on the surface of the conveyor (4) instead creates a worse effect because the inertia of the robot axes and small delays in response lead to the robot effector moving in a circular path relative to the vehicle (1) and out of phase with the positional periodic variations in the vehicle position. Acceleration or deceleration of the conveyor (4) also adversely changes the offsets.

The applicants have developed an error correction technique which overcomes this problem and makes ‘on the fly’ automation possible.

This is achieved through comparison of the frequency and amplitude of relative movement measured using the robot guidance system over several cycles with the output from an additional optical sensor (12) on the conveyor inside the cell. The robot insertion action is synchronised to the peak of conveyor movement so that the component (8) always approaches the vehicle (1) at the same stage of the sampled conveyor cycle. This control as well as overall co-ordination of the cell is provided by the Programmable Logic Controller (13). Conveyor monitoring detects speeding up and slowing down and waits for steady speed before insertion. If the conveyor (4) stops, the robot (7) repositions, remeasures and executes the static routine. The conveyor is held stopped until the process is complete.

The robot (7) therefore gradually brings the part for assembly (8) as close as possible to the target area to minimise final action time, whilst continually tracking the conveyor (4) and responding to feedback from the robot guidance system (10,11). Once at the limit point, the robot waits for the synchronisation signal, makes final calculations and quickly moves the part (8) into position. Through continued conveyor tracking the component (8) can be held in position with the required pressure or whilst other fastening devices to execute their cycle.

Once the process is complete, the robot (7) withdraws from the vehicle (1), retrieves the next part (8) and waits in position for the next vehicle (1) to arrive.

‘Adaptive’ Robot Automation (Numbers Refer to Elements of FIG. 1)

The vehicle (1) will be presented on a delivery system such as a skid (3) on a conveyor (4) or in an overhead carrier or on a floor skillet (large fixture with walking platform and pushed by rollers rather than dragged by a chain). This will come to a standstill in front of the robot (7). The nominal stop position will be consistent, i.e. stopped in a particular station, but there is, with the present invention, no need for heavy tooling and clamping to ensure accurate, known positioning.

Mounted on the robot (7) is a contactless displacement sensor (10). This is a distance-measuring laser either for point or profile (line) measurement, typically accurate to +/−15 microns.

The Programmable Logic Controller (13) provides overall co-ordination and directs the robot controller (5) to move the robot through a sequence of steps, each dependent on the result of the previous one. The laser sensor (10) is set to act as a switch, tripping when it is a fixed distance from a surface. The robot starts at the extremes, finding the outer surface, then works in to find detail. Specific co-ordinates are found by first identifying a surface, then an edge, then a point.

For each reading, the position and orientation of the robot axes are captured from the robot controller (6) and recorded. The laser measurement PC (11) processes the data and through innovative ‘number crunching’ translates the readings into co-ordinates of the points in space. There are three possibilities for using this data:
1. The same robot that took the measurements uses the co-ordinates within its own envelope to execute an action on the workpiece measured.
2. Another robot in the same station uses the absolute spatial positioning co-ordinates to execute an action based on measurements by the first robot. This requires accurate knowledge of the relative mapping of the robots' respective co-ordinate envelopes.
3. Measurements are recorded and logged against Vehicle Identification Number (VIN) for use by robots in a different station. One measurement station is required at the head of the line to take multiple readings of each individual vehicle. One master robot in each subsequent station locates two of the points, then all robots in that station will know where the other points are and can tailor the operation to that particular vehicle.

Possible applications of this technique include but are not limited to the following. Examples of where they have been successfully implemented are given in brackets.
Determine location of screw threads for positioning part centrally around hole or stud then running down bolts or nuts to fix part in place. (See Instrument Panel example below).
Determine actual position of carrier in order to locate part positions within it (See Decking example below).
Determine endpoints of a profile in order to calculate its actual position and orientation in space so a fixed path can be transformed to follow it. (e.g run a sealer bead along an engine compartment cowl top with uncertain location).
Determine multiple points along a route so that a robot path can be created to follow it exactly (e.g. seam sealer bead along a van bodyside to roof overlap).
Determine X,Y,Z offsets to numerous key points from defined origins for subsequent robots to reference (see seam sealer deck example below).

When an ‘adaptive’ cell is installed, the same displacement sensor is used by the robot to learn about its surroundings, for example its position relative to the conveyor and any gradients. This is done once and makes it possible to overcome any differences between the ‘as-installed’ and design conditions.

### EXAMPLES

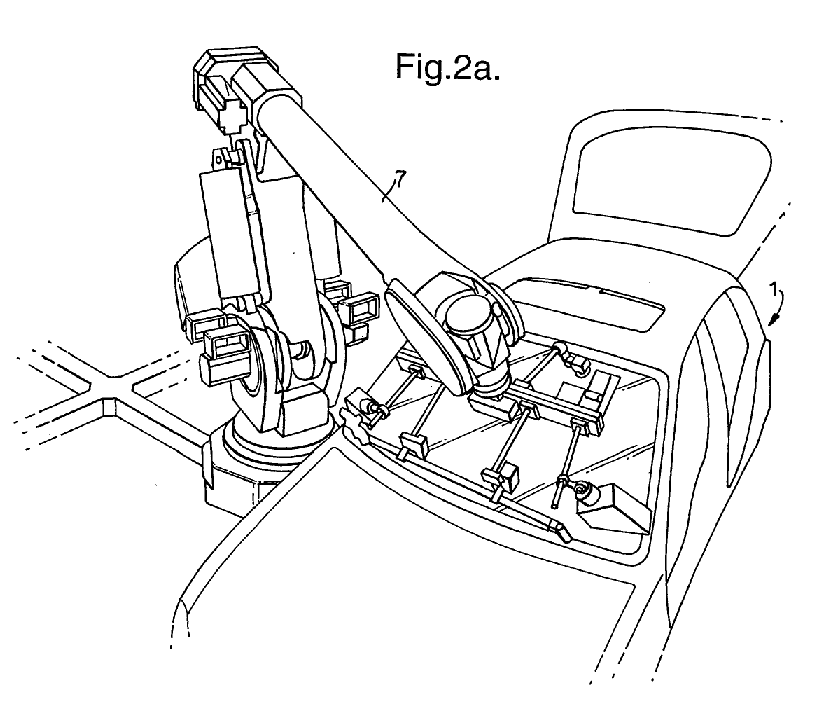

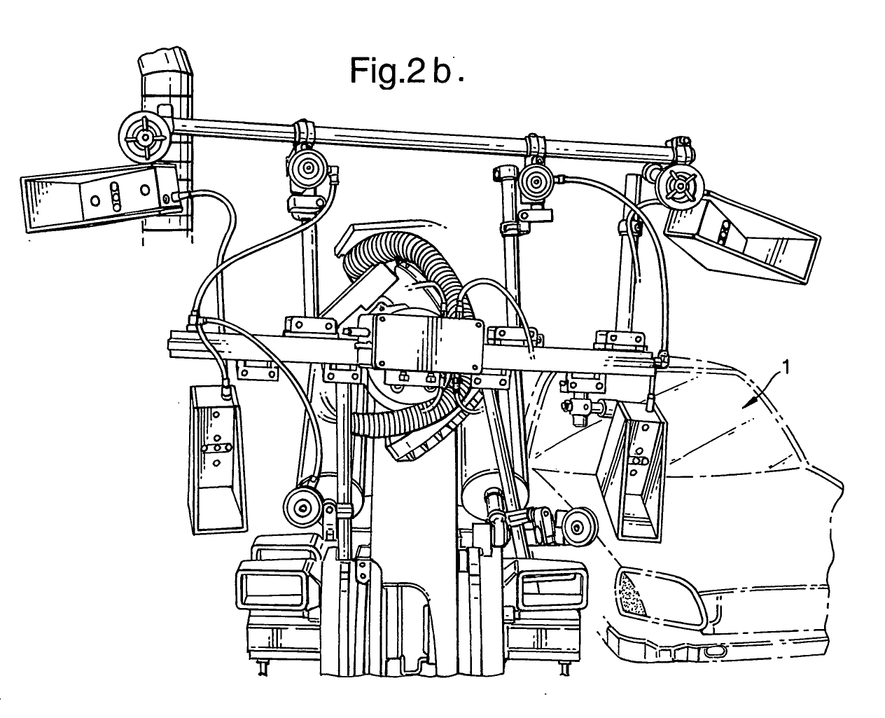

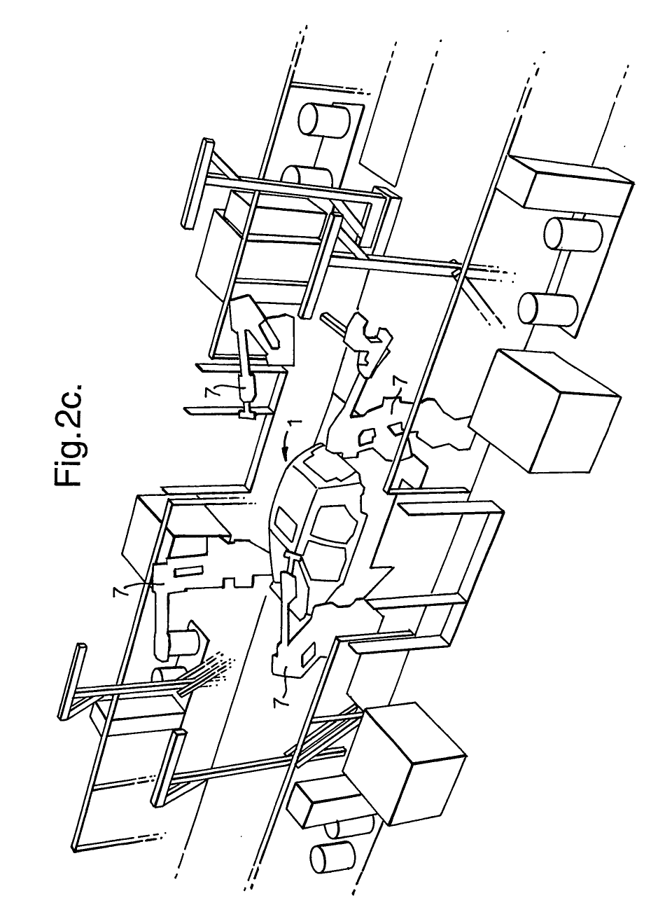

1. Robot Glazing (Pictures in FIG. 2)

The glazing cell illustrated is a prime candidate for application of the principle of ‘on-the-fly’ component insertion in accordance with the invention. The cell illustrated is designed to use a dynamic glazing principle where the car body travels on its original skid and conveyor system through the glazing cell without stopping. The robot responsible for decking the front windscreen has to follow the moving car body through the cell as shown in FIG. 2(a). The process described here is similar to ‘on the fly’ above but with a focus on windscreen glass. In this embodiment, the robot effector includes a vacuum suction pad to hold the windscreen without damaging the latter.

The tracking function for the robot is achieved by connecting a digital encoder to the conveyor drive to measure the conveyor position at any time. This robot interprets the signal and uses it to synchronise itself with the conveyor. This synchronising routine is performed in the robot as a background task performed by an optional software package supplied by the robot manufacturer.

As the car body enters the cell it passes over two detection sensors. These send a signal to the robot to start the tracking function. The robot moves across in front of the car body positioning the glass 120 mm in front of the windscreen aperture and follows the body along the conveyor. At this time the robot gives a signal to the guidance system to start measuring the relative position of the robot to the car body.

Mounted on the end effector are four reflective laser distance measurement sensors as shown in FIG. 2(b). The guidance system takes multiple readings from the windscreen aperture to determine the offsets required for the robot to place the screen into the correct place in the car body and sends this data to the robot over a serial connection. Once the robot has received the offsets from the guidance system, the robot moves to the decking position and inserts the windshield into the car into the correct position.

The robot then applies an extra amount of pressure on the windscreen to overcome the elasticity of the polyurethane sealer which was pre-applied to the windscreen. The robot holds this pressure for a pre-set time to ensure the polyurethane has flowed into the windscreen aperture. The robot releases the vacuum on the glass and moves back to the home position, ready for the next vehicle.

In order to insert the glass into the car, the robot must to be able to accurately track the moving car body. From experience it has been found that the car body typically does not move smoothly along the conveyor but moves in a lurching fashion along the conveyor. This ‘lurching’ is because the drive from the conveyor motor to the conveyor chain is through a drive sprocket. This sprocket converts the smooth movement from the drive motor to lurching movement on the conveyor chain.

The robot then is moving in a smooth path given by the drive encoder, whereas the car body is not moving smoothly on the conveyor through the cell. The resulting effect is that the robot is moving in a lurching motion relative to the car body. This lurching can be detected by the robot guidance system.

In an attempt to overcome this problem, in the work which led to the present invention, the encoder measuring the conveyor position was moved from the drive end of the conveyor, onto a wheel running in contact with the conveyor surface, inside the glazing cell. This provided an accurate representation of the actual position of the car body in the glazing cell, emulating the lurching motion. This signal was sent to the robot to track the car body and the data from the vision system was analysed. The readings taken from the guidance system showed that the resulting movement between the car body and the robot was worse than with the previous set up.

The robot was found to be trying to convert the changing motion along the straight-line conveyor direction into the corresponding motion required for the glass to follow the car body. But because the robot axes are rotational and each one has a different size and inertia, the resulting motion of the windscreen on its robot gripper followed a circular path in front of the car body. In addition to the circular motion the robot was out of phase with the lurching conveyor system, this was caused by the processing time of the background tracking-routines in the robot manufacturer supplied package. The combination of these effects thus made the relative position of the robot holding the glass and the car body windscreen aperture much worse than with the previous set up.

Additional issues were identified when the robot tried to follow a slowing down or speeding up conveyor system. Owing to circular movement and the lag found in the previous example, as the robot tried to follow the conveyor the offsets become much larger as the conveyor was accelerating or decelerating. When the conveyor reached a constant speed the offsets once again became constant.

All of these issues meant that although the guidance system could measure the offsets required for decking the glass, the robot could not consistently put the windscreen into the same place in the car body.

To investigate these problems, the guidance system was used to measure the robot errors relative to the car body to find which encoder arrangement provided the better results.

It was determined that putting the tracking encoder back onto the drive gave the robot a smoother signal, which could be used to perform a consistent tracking function. The period and frequency of the car body movement was measured by the guidance system. This was used to determine the peak of the relative movement and a sensor was installed onto the conveyor inside the glazing cell to synchronise with the peak of the conveyor movement with the glass insertion. The sensor signal was sent back to the robot.

In the glazing cell of the invention, the guidance system measures the car body aperture over successive cycles of the conveyor motion. This signal is ‘analysed’ by the cell control software systems to calculate the robot error and send the new error correction signal values to the robot. In this way the guidance system, together with the cell control software system is used to correct the robot tracking errors.

To ensure the robot inserts the glass consistently in the same place in the car body for each vehicle, it must approach the car at the same time during the conveyor motion. This is achieved by using the conveyor synchronising signal, which prevents the robot from inserting the glass until the signal resynchronises with the conveyor position. The robot will always be at a known position relative to the vehicle and will insert the glass at the same part of the sampled conveyor motion, thereby producing a consistent insertion position and providing a means to correct the robot errors.

To overcome the speeding up and slowing down errors a different strategy was put in place. As the robot gave different offsets during the changing conveyor speeds it was no longer possible to average the readings taken by the guidance system to overcome these errors. The control system was modified to monitor the conveyor running status during the measuring period of the guidance system.

If the conveyor started or stopped during the measuring then a signal was sent to the robot to abort the measuring and decking. If the conveyor stopped whilst the cameras were measuring the aperture, the guidance system would stop, wait for the robot to reposition the cameras in front of the aperture and then re-measure the offsets under the robot's ‘static’ routine. The control system holds the conveyor in a stopped state until the decking is complete.

The accuracy of the robot tracking is particularly critical in the glazing cell. The invention has been tested in a set-up using a glass rubber surround on the windscreen, designed for a manual insertion and not an automatic one. The rubber surround actually wraps underneath the glass during decking causing ‘lipping’ of the rubber onto the car body. In the manual operation the glass is inserted and lifted several times by the operator to eliminate the ‘lipping’. Due to the issues with the robot tracking, it is impossible for the robot to replicate this action.

To resolve the rubber ‘lipping’ problems, the glass insertion is programmed in a series of steps. These steps demand very fine robot movements relative to the car body, and error correction obtained through the development of the software systems on the cell.

A further technical advance in glazing cells has been found, by the invention, to be the use of transducers on a centring table to actually measure the glass dimensions, rather than just centring the glass in the aperture. Glass can therefore be rejected if out of tolerance.

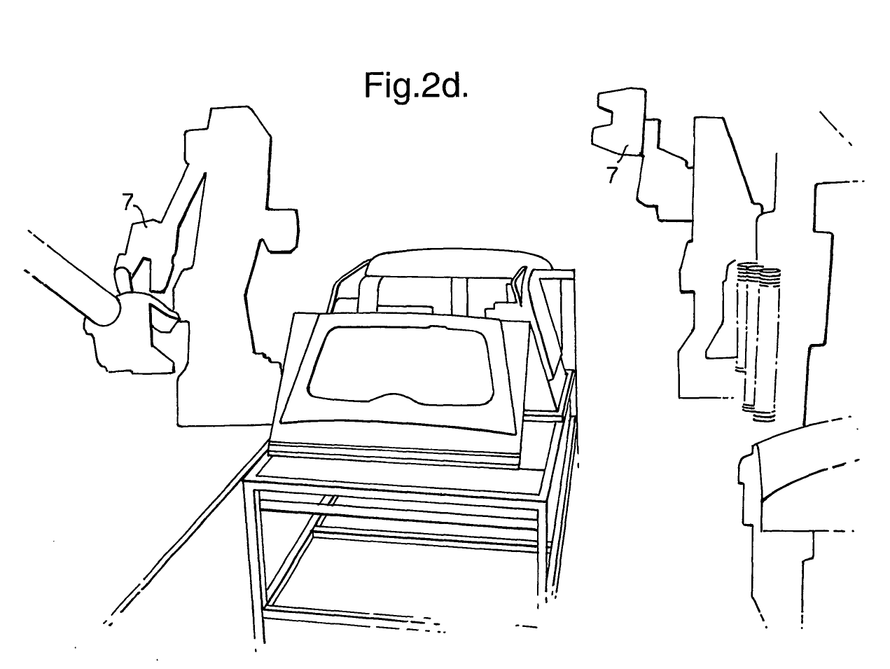

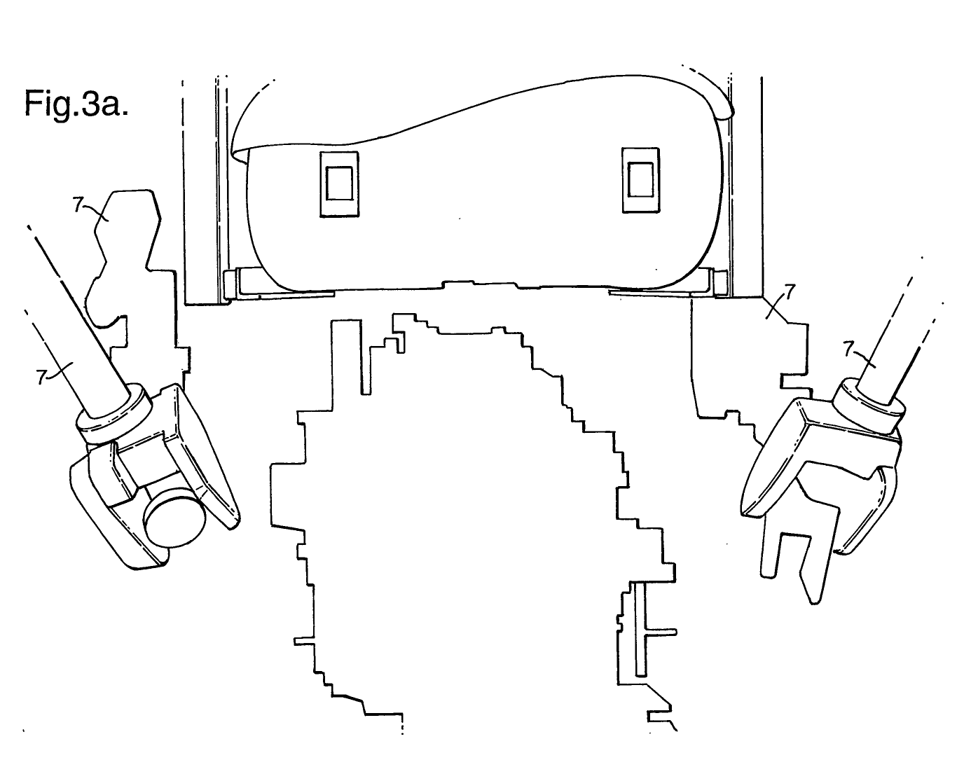

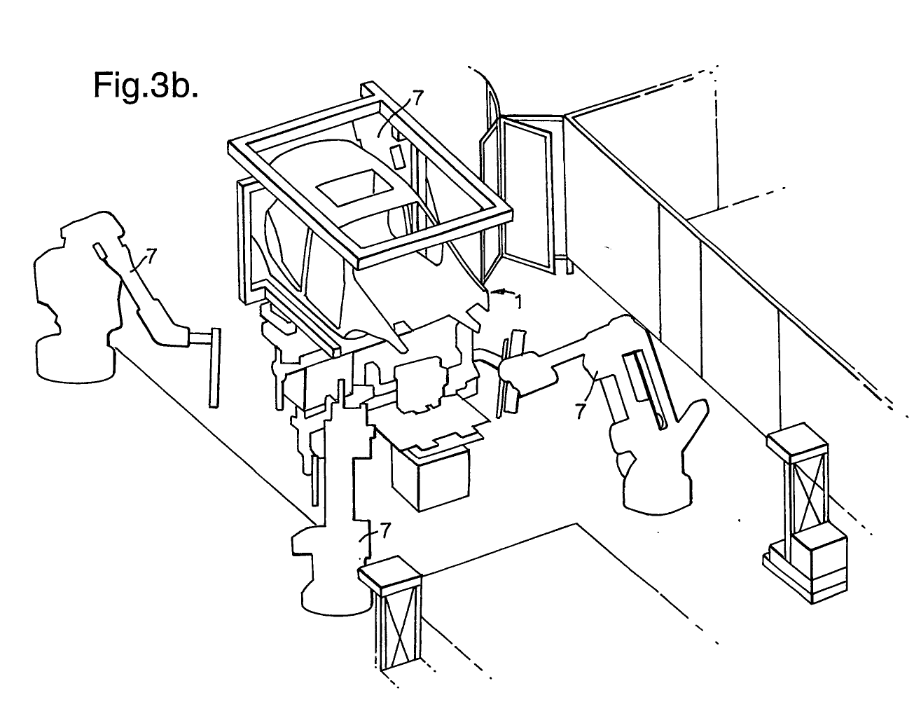

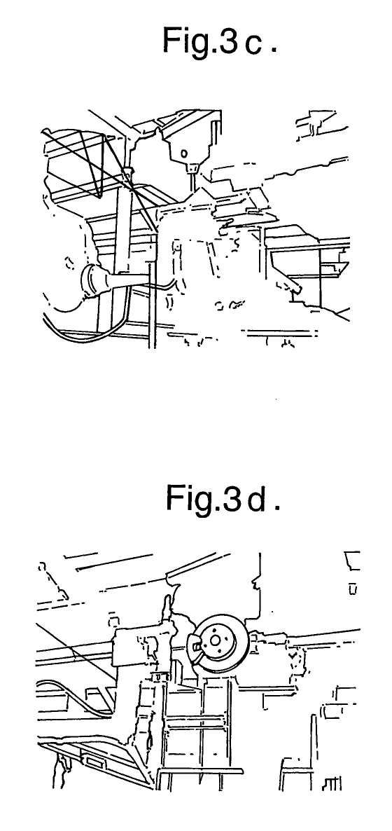

2. Robot Decking (Pictures in FIG. 3)

The illustrated automatic decking of the engine and transmission is based on the robot guidance, error correcting and ‘adaptive’ techniques already referred to.

When an engine and transmission is decked into a vehicle, the final location will be in a different position for each vehicle. These positional errors are due to factors such as the transport conveyor stopping position, transport conveyor tolerances, vehicle body tolerances, engine and gearbox tolerances and decking table tolerances. All these interact with each other leaving the final bolt positions for the attachment to the vehicle at different positions for each vehicle.

The ‘normal’ solutions for such issues are to build extensive tooling into the decking facility to control these errors. This results in a non-flexible machine, as each different body, engine and gearbox type must be accommodated into the tooling designs. Future model changes are expensive and require extensive modification to the facility.

The robot ‘adaptive’ software systems allow such a cell to be built without this extensive tooling. The four robots shown in FIG. 3 each carry a nut-runner to run down the fixing bolts, and a robot guidance system. The robots first find the vehicle when it is presented to the cell by the transport system. Each robot finds the offset of the vehicle in space and calculates the relative position of the body using body type information from the plant scheduling system.

This enables the robot, for example, to manipulate the front suspension strut into position into the vehicle body as the auto decking takes place. This would normally require a complex piece of dedicated tooling, which can now be replaced by a flexible robot solution. The robot guides the strut into position until the decking is complete (see FIG. 3(c)).

The robot then once again uses its guidance and software systems to find the final resting position of the decking table (see FIG. 3(d)). It can then locate the bolts that fix the engine and transmission to the vehicle and run down all the bolts thus fixing the whole assembly together.

This solution gives very significant cost savings over dedicated auto-decking systems. The cell only occupies one station on the assembly line. Re-tooling for different models is a software function, which allows for mixed model production and re-use on future production. In addition the cell can operate in a manual mode if there are serious operational difficulties with the robots thereby ensuring continued production.

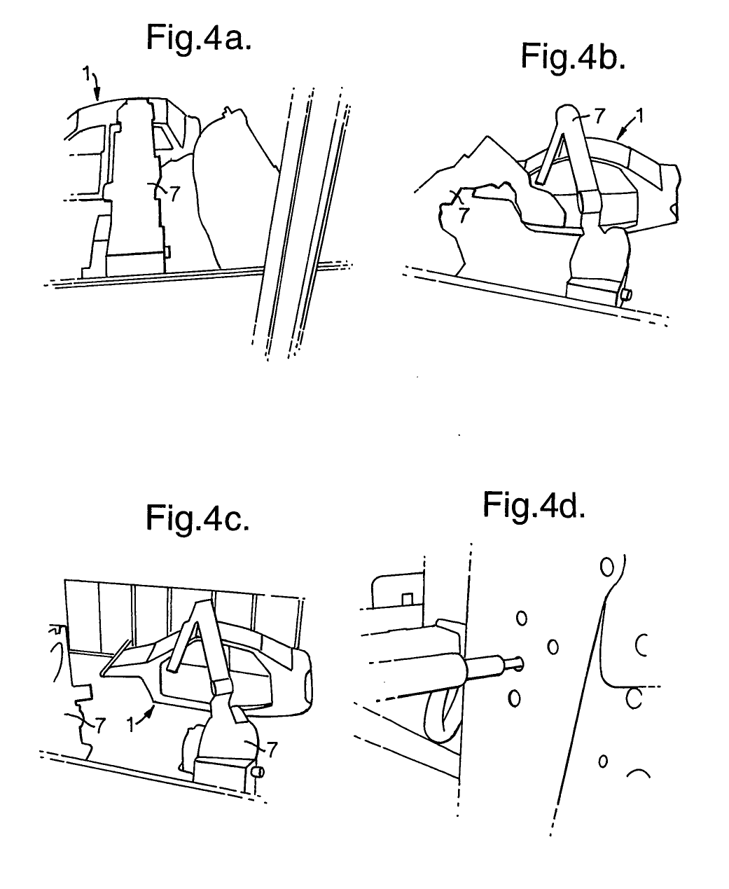

3. Robot Instrument Panel Assembly (Pictures in FIG. 4)

The Instrument panel decking cell consists of three robots, two of which have robot guidance and software systems and also carry nut-runners. The third robot has a gripper that has been designed for multi-model capability.

The two laser guided robots search for the fixing surface of the Instrument panel in the vehicle and the captive nut positions for the retaining bolts. The vehicle is transported into the cell on a floor skillet system, no further tooling is required to fix the position of the skillet, the robot guidance systems find the vehicle in ‘space’. Meanwhile the third robot is picking up the instrument panel (FIG. 4(a)).

The two guidance robots send the vehicle body measurement data to the third gripper robot. From this data the third robot calculates the offsets required to centre the instrument panel in the vehicle. It manoeuvres the instrument panel into the vehicle and holds it in position and signals for the two nut-running robots to run down the fixing bolts (FIGS. 4(b) and 4(d)).

Once again this provides software re-tooling and mixed model production capability. Every vehicle that is assembled is measured and checked for dimensional accuracy and quality data is automatically collected and stored for later 6-sigma analysis. The cell can be re-used for future model production.

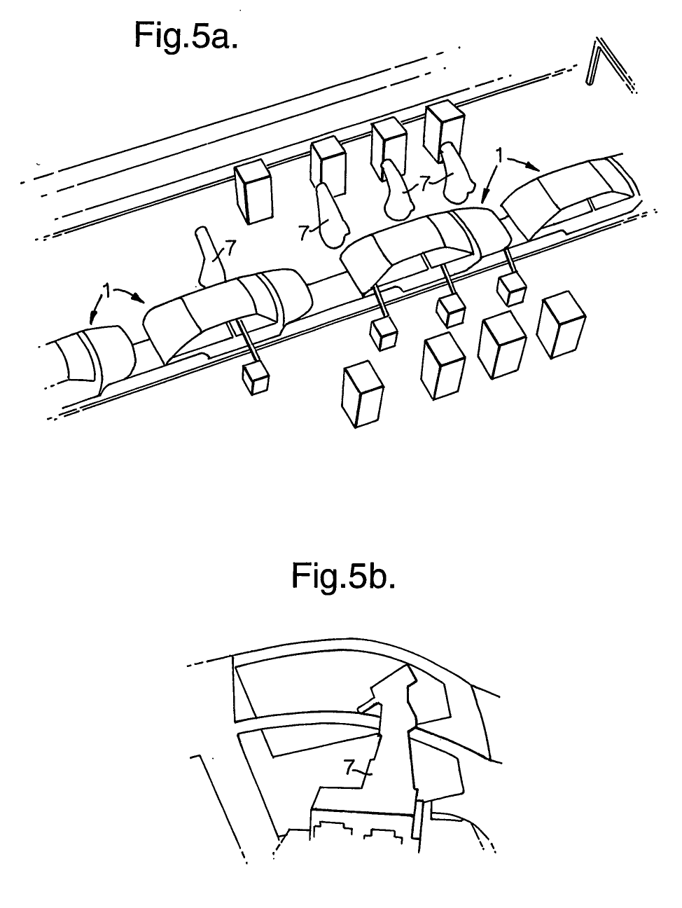

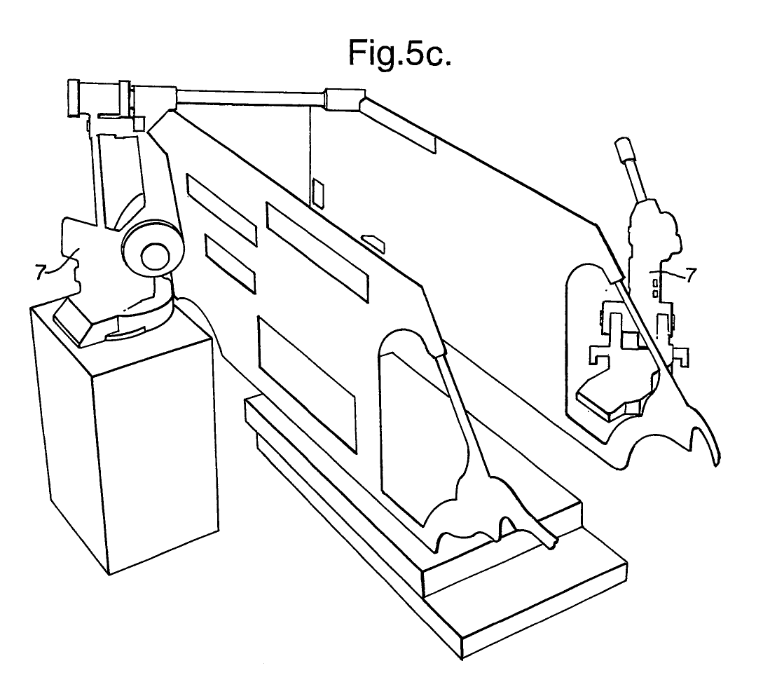

4. Robot Seam Sealer Deck (Pictures in FIG. 5)

The body shell of a vehicle goes through many production processes before it reaches the sealer deck area in the paint shop. Each of these processes builds up offsets in the body shell away from the datum. Stamping, tooling, welding, e-coat application and ovens all distort the body shell away form the norm. This is a normal part of the manufacturing process, its effect however is that every body shell is unique and has individual dimensions (within manufacturing tolerances). The normal approach in the sealer deck area (and general automation solutions elsewhere in the manufacturing process) is to clamp the body shell on its underbody master location pins. As one moves away from this tooling point, the offsets in the body shell increase.

To cope with this variation, the normal application of sealer material produces a spray of sealer, which is greater than these tolerance build-ups. This requires a much larger quantity of sealer material than is really necessary to seal the seams. Some is later brushed off the body and there is no guarantee that the sealer has actually covered the seam. It also prevents the automated application of sealer in areas where the required sealer bead thickness is less than the dimensional tolerances at that point.

Robot guidance systems in accordance with the invention can be used to overcome these deficiencies.

At the first station in the sealer deck there are two robots with guidance and software systems, which dimensionally check each body shell. The data collected from this gauging process is written to a database together with the vehicle ID and this data is available for 6-sigma analysis. This gauging process measures the body shell offsets away from the ideal body shell created when the body was designed. This database of body offset data is passed along the sealer deck with the body shell. See FIG. 5(a).

When the body shell enters a sealer robot application station, the data is transferred to the robots in that station. These robots now have an ‘image’ of the individual offsets of the body shell to work on. This allows the robot to accurately apply sealer to the seam, reducing the amount of sealer usage, and ensuring accuracy.

During the gauging process the gap between panels is also measured, this allows the robot to apply the correct volume of sealer to fill the required gaps. This process also allows application of sealer to areas where this was not previously possible because of tolerance build-up. This increases the amount of sealer operations that can be applied by automation. Each station along the line is designed in the same way, leading to a modular approach.

The use of robot guidance systems allows for mixed model production and offline robot programming. Software re-tooling, mixed model production and re-use for future model production is achieved by the removal of hard points of tooling and the use of digital buck generated robot program data. Offline robot programming has been available for some time but has always had problems in the implementation phase because of body shell tolerances. These tolerances are such that the actual robot on the production shop floor cannot use the digitally created data without robot re-programming by robot programmers on the commissioning phase of the automation. The use of robot guidance and software error correcting systems has allowed the robot to adapt to the actual production conditions experienced in the manufacturing plant environment.

Key Benefits:

Eliminates expensive modifications to existing skid and conveyor systems.

Eliminates heavy tooling and clamping requirement.

Eliminates unergonomic manual processes such as lifting, bending, stretching and hammering whilst moving with a vehicle on a line.

Superior quality and repeatable results from high accuracy reduces warranty and rework costs.

Major manpower savings possible.

Mixed Model Production, removal of hard automation replaced with flexible robot/guidance and software systems. This enables automation cells to begin to deliver the ideal of mixed model production and aids progress towards a ‘model-independent’ factory able to produce any product on demand.

Modular, standard cells for glazing, sealer, decking and many other applications can be built and incorporated in different manufacturing plants making different models and mix. The robot guidance and software systems can be utilised to solve many different manufacturing difficulties.

Flexible, multi model types can be built using the same facility. The robot guidance and software solutions can be applied to many different processes.

Re-useable, the automation cells can be re-used for future model production, no need to start again from the beginning and design new. Cells are transferable to other stations or plants once process lifecycle expires.

Software re-tooling, in many instances the cell can be re-configured by software only, this can be done from digital data thereby allowing for offline robot program creation.

Error correcting, inherent errors in the robot systems and body variances can be accommodated and corrected using this technology.

Adaptable, for future model types and applications. The robot guidance and software modules can be adapted to many automation requirements.

Multi-usage, this technology can be usefully employed across the breadth of the manufacturing environment. In some cases automating processes that were previously not possible.

Recovery systems are designed in from the outset to maintain production in the event of a machine breakdown.

Cost effective, the glazing cell, engine decking and instrument panel insertion cells offer considerable savings over normal automation by removing costly tooling locating mechanics. The sealer application process enabled the automation of considerably more material coverage than normal methods. Savings for future model re-tooling are also significant.

On-The-Fly, this technology allows automation of trim and assembly shops. The trim shop has the highest concentration of labour anywhere in the manufacturing process. Trim shops are based around a continuous process line. Automation of the trim processes is now viable.

6-Sigma, data is a by-product of this technology. Every body is measured by the guidance equipment and compared against the norm. This data is available for 6-Sigma analysis.

Gauging, every body undergoes a gauging process. Every body is measured and checked against the digital data. Out of process errors can be captured and corrected much more reliably. Traceability is built into the process.

It is to be understood that the invention can be carried out using apparatus significantly different from those illustrated and described and various modifications, both as to the equipment details and operating procedures can be accomplished whilst remaining within the scope of the invention.

The invention thus provides, inter alia:—

1. An ‘on the fly’ intelligent automation cell, comprising an industrial robot and controller with conveyor tracking ability, robot guidance system and error correction functionality in order to perform actions on a moving target.

2. An error correction element of 1 wherein the robot can overcome non-linear conveyor motion and variation between vehicle position and robot tracking to undertake operations relative to the vehicle with high accuracy and repeatability.

3. ‘Adaptive’ robot automation where laser displacement sensors are directed by a robot to pre-measure points and profile on a vehicle in order to use the information to customise subsequent robot actions to that vehicle

4. A robot “glazing on the fly” cell incorporating conveyor tracking and laser offset measurement techniques to insert windscreens into vehicles moving on a conveyor.

5. A robot decking cell using laser displacement sensors to determine vehicle body position for robots to guide front suspension struts, and decking table location for robots to find nut runners.

6. A robot instrument panel assembly using laser measurement to locate the screw threads for the fixing bolts then run them down after centralising the IP.

7. A robot seam sealer deck using ‘adaptive’ techniques to pre-measure the vehicle body and pass the information along to subsequent stations.

As will be appreciated from the above, present invention is applicable, inter alia, to a number of common processes in an automotive plant.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A robot manufacturing facility including at least one robot for acting on a workpiece or intermediate product of a pre-calculated shape and dimensions at a pre-calculated position and orientation relative to a reference frame, the robot including a body or base structure, at least one member movable with respect to said body or base structure for acting on such workpiece or intermediate product, means for effecting such movement and sensing means for sensing the position of said member, the last noted means including means for sensing the position of the workpiece or intermediate product relative to the robot or to said member thereof and means for controlling the movement of said member relative to said body or base structure according to a predetermined program, modified in accordance with signals from said sensing means, whereby the robot is able to compensate for departures from said pre-calculated values of the position and orientation and/or shape and/or dimensions of the workpiece or intermediate product.

2. A facility according to claim 1 wherein said sensing means includes light sensing means.

3. A facility according to claim 2 wherein a laser light source is carried by the robot and said sensing means includes means for detecting laser light, from said source, reflected from the workpiece or intermediate product.

4. A facility according to any preceding claim including continuously moving conveying means for moving successive workpieces or intermediate products through a plurality of work stations in sequence and wherein said robot is located at a said work station and is arranged, during an active part of a work cycle thereof to effect, in relation to each said workpiece or intermediate product passing through the station, a primary movement corresponding to the mean velocity or rate of progress of such workpiece or intermediate product through the work station, and a superimposed, secondary movement determined by positioning errors or discrepancies determined by said sensing means.

5. A facility according to any preceding claim wherein said sensing means is located on the part of the robot, (herein also termed the “end effector”), which directly acts on the workpiece or intermediate product or on a part as close as possible to the first-mentioned part.

6. A method of programming an industrial robot, comprising developing a 3D virtual model of a workpiece or intermediate product, determining, on a virtual basis, required movements of a robot tool relative to such model for a manufacturing procedure to be carried out thereon, providing to a computer program data defined by said 3D virtual model and said virtual required movements, and controlling a real robot, in a real workshop/factory space in relation to a real workpiece or product, the real robot being provided with sensing means for sensing the positions relative to a fixed datum of such robot of key parts of such product identified by said sensing means in conjunction with said program and the progam being arranged to control the moving parts of said robot to reproduce the predetermined movements of the same, relative to the workpiece.

7. A method according to claim 6 including providing a display, in real time, of the operation of such virtual 3D model.

8. A method according to claim 6 wherein said program is arranged to adjust the movements of the robot to allow for sensed variations in dimensions or shape of individual said workpieces.

9. A method according to claim 6 or claim 7 wherein the real robot is arranged to sense bulk movements of the workpiece relative to a fixed reference frame during a work cycle and the computer and program are arranged to derive, over successive nominally identical work cycles on successive nominally identical workpieces, a set of average values representing a mean pattern of such movements during a mean such work cycle, and to apply during each work cycle, superimposed corrective movements in accordance with departures from the mean size, shape and positioning of the respective product from cycle to cycle as sensed by said sensing means.

10. A method of setting up a manufacturing facility, such as an assembly line, comprising setting up, within a computer, in terms of corresponding sets of data, a virtual factory in virtual manufacturing premises with dimensions corresponding to the real premises available, virtual machinery comprising data as to dimensions, to positioning, movement and timing of such machinery, and virtual personnel with corresponding data as to dimensions, limits of safe movement, speed of movement and the like and adjusting the data which is variable and thus represents degrees of freedom of the facility to arrive at an efficient workable arrangement.

11. A method according to claim 10 including providing a visual display of the operation of the virtual factory.
